(19) United States
(12) Patent Application Publication
(10) Pub. No.: US 2007/0035960 A1
(43) Pub. Date: Feb. 15, 2007

(54) Illuminated pointer

(75) Inventors: Vyacheslav B. Birman, Auburn Hills, MI (US); Ronald Struck, Flushing, MI (US); Kevin M. Dyer, Macomb Twp., MI (US); Kenichi Takato, Rochester Hills, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/584,088

(22) Filed: Oct. 20, 2006

Related U.S. Application Data
(63) Continuation-in-part of application No. 11/186,340, filed on Jul. 21, 2005.
(60) Provisional application No. 60/740,986, filed on Nov. 30, 2005.
(60) Provisional application No. 60/729,024, filed on Oct. 21, 2005.

(51) Int. Cl. B60Q 1/00; B60Q 1/26

(52) U.S. Cl. 362/489

(57) ABSTRACT

A gauge assembly includes a pointer that provides one appearance in a non-illuminated condition and different appearance an illuminated pointer for low light conditions. The pointer is selectively illuminated to provide enhanced viewing in low light conditions. The pointer assembly includes a film that provides for desired appearances in daylight conditions and also defines a desired multi-colored pattern.

### CROSS REFERENCE TO RELATED APPLICATION

This application is a continuation in part of U.S. application Ser. No. 11/186,340 filed on Jul. 21, 2005 and claims priority to U.S. Provisional Application No. 60/729,024 which was filed on Oct. 21, 2005 and U.S. Provisional Application No. 60/740,986 which was filed on Nov. 30, 2005.

### BACKGROUND OF THE INVENTION

This invention generally relates to an indicator for an instrument panel. More particularly, this invention relates to a pointer providing a desired non-illuminated appearance and a different illuminated appearance.

A vehicle instrument panel includes a dial face including numbers or other indicators utilized for indicating a vehicle operating parameter such as speed, and engine rpm. A movable pointer rotates relative to the dial face to provide the desired indication of the measured operating parameter. In some applications, the pointer is illuminated from behind the dial face. Light is guided through a shaft supporting the pointer, and reflected through the pointer to produce the desired illuminated appearance.

An instrument panel for a motor vehicle not only provides for the communication of vehicle operating information, but is also a design feature that incorporates aesthetic features. The aesthetic features increase the desirability of purchasing one vehicle over another. For this reason many different aesthetic features are designed into the instrument panel. Further, new vehicle models also incorporate different features to communicate the updated nature of the motor vehicle.

Accordingly, it is desirable to develop and design aesthetic features for an instrument panel to provide a desired and updated appearance.

### SUMMARY OF THE INVENTION

A gauge assembly includes an illuminated pointer that emits a desired color and appearance when illuminated and a different appearance when not illuminated.

An example gauge assembly includes a face including a plurality of markings that define a scale. A pointer assembly moves relative to the face to indicate a measurement by pointing to a particular marking. The pointer is selectively illuminated to provide enhanced viewing in low light conditions. The pointer assembly includes a film that provides a desired appearance.

One example of the pointer includes a semi-transparent film to permit illumination from the pointer portion to become visible to a user. However, the film provides a different appearance from the illuminated pointer when in a daylight non-illuminated condition. The film provides a metallic appearance when the pointer is not illuminated. A pointer mask controls the emission of light from the pointer portion such that light is only directed upwardly through a top surface of the pointer assembly.

Another example pointer includes a polycarbonate sheet that provides for illumination of the pointer in different colors. The polycarbonate sheet is printed with colors in the same process that a dial face is created. The colors on the polycarbonate sheet used for the pointer therefore match the colors of the dial. Example pointers include a polycarbonate sheet defining a desired illuminated pattern of one or many colors depending on a desired application. Another example includes an additional polycarbonate sheet with a smoked and blacked out image to provide a non-illuminated blackout appearance of the pointer.

Accordingly, the example pointer assemblies provide different illuminated and non-illuminated appearances with different colors or visible appearances to enhance the visual appearance of an instrument assembly . . .

These and other features of the present invention can be best understood from the following specification and drawings, the following of which is a brief description.

### BRIEF DESCRIPTION OF THE DRAWINGS

FIG. 1 is a schematic view of an example gage assembly.

FIG. 2 is a schematic cross-section of the example gauge and pointer assembly.

FIG. 3 is a schematic view of an example pointer assembly.

FIG. 4 is a cross-sectional view of the example pointer assembly.

FIG. 5 is a front view of an example dial assembly including an illuminated pointer.

FIG. 6 is a top view of example multi-colored illuminated pointers.

FIG. 7 is a cross-sectional view of an example dial assembly and illuminated pointer.

FIG. 8 is a cross-sectional view of another example dial assembly and illuminated pointer.

FIG. 9 is an exploded view of an example illuminated pointer.

FIG. 10 is a view of an example pointer cap.

FIG. 11 is a perspective view of an example formed pointer sheet.

FIG. 12 is a bottom perspective view of the example formed pointer sheet.

FIG. 13 is a front view of an example blacked out dial assembly.

FIG. 14 is a front view of the example dial assembly in an illuminated state.

FIG. 15 is a sectional view of an example illuminated pointer that is blacked out when not illuminated.

### DETAILED DESCRIPTION OF THE PREFERRED EMBODIMENT

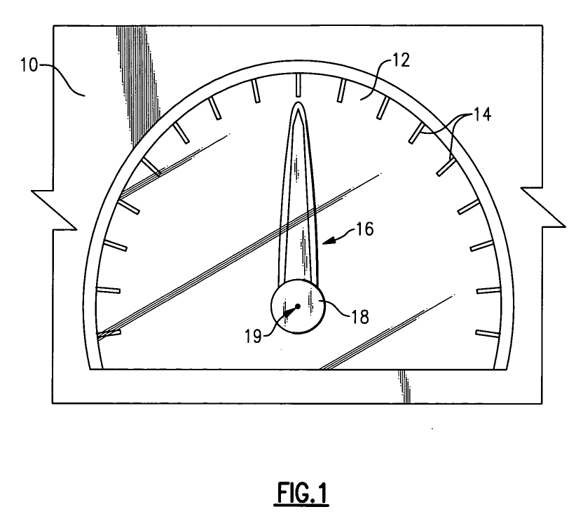

Referring to FIG. 1 an example dial assembly 10 includes a face 12 including a plurality of markings 14 that define a scale. A pointer assembly 16 moves relative to the face 12 to indicate a measurement by pointing to a particular marking 14. The pointer 18 is selectively illuminated to provide enhanced viewing in low light conditions. Further, the pointer assembly 16 includes a film that provides for desired metallic appearances in daylight conditions. The pointer assembly 16 includes a mask 18 disposed about an axis of rotation 19. The example mask 18 substantially prevents light from being emitted or directed in an undesired direction.

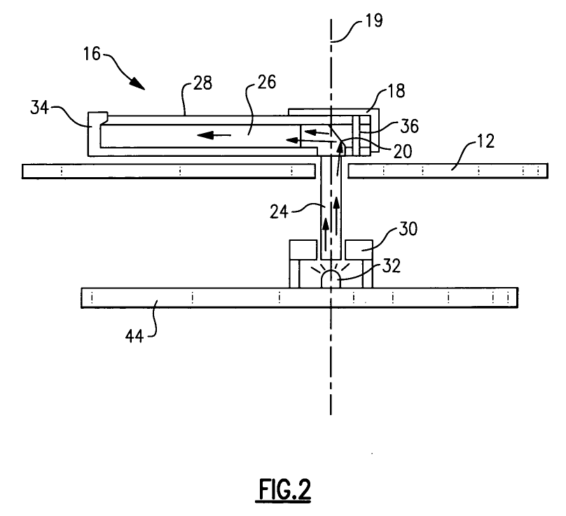

Referring to FIG. 2, the pointer assembly 16 is illuminated by way of light emitted from a light source 32. Light from the light source is directed through a shaft 24 and into a base portion 20 of the pointer assembly 16. A motor 30 is schematically shown and provides for rotation of the pointer assembly 16 relative to the face 12.

The pointer assembly 16 includes a pointer 15 having an elongate pointer portion 26 that extends from the base 20. The base portion 20 is supported atop the shaft 24. Light from the light source 32 is directed upward into the base portion 20 and is directed through the pointer portion 26 to provide the desired illuminated appearance in low light conditions. The mask 18 covers the base portion 20 and covers the axis 19 to prevent incoming light through the shaft 24 from creating a bright spot visible to an operator or other user.

The pointer portion 26 is covered by a film 28. The example film 28 is semi-transparent to permit illumination from the pointer portion 26 to become visible to a user. The film may comprise a polycarbonate material onto which a desired color or pattern can be printed. However, the film 28 provides a different appearance from the illuminated pointer when in a daylight non-illuminated condition. In the example, the film 28 provides a metallic appearance when the pointer 16 is not illuminated. The metallic appearance is provided by a coating disposed on a top portion of the film 28. The example pointer portion 26 is masked on the sides by a pointer mask 34. The pointer mask 34 controls the emission of light from the pointer portion 26 such that light is only directed upwardly through a top surface of the pointer assembly 16.

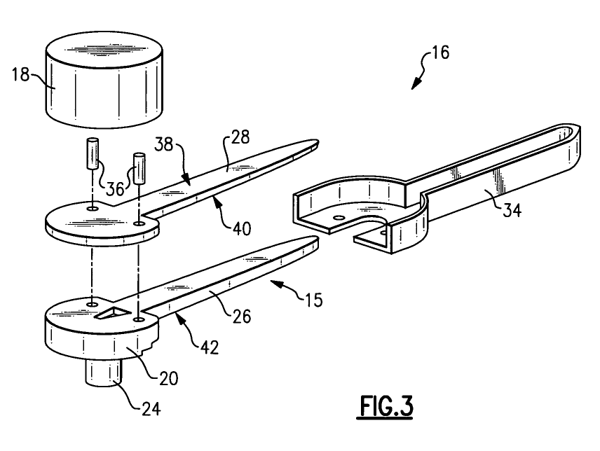

Referring to FIG. 3, the example pointer assembly 16 is shown in an exploded view and includes the film 28 that is placed on the top surface of the pointer 15. The example film 28 is attached to the pointer 15 by a mechanical attachment means. The example film 28 includes openings for pins 36. The pins 36 extend through the film 28 and into openings within the pointer 15. The mask 34 is also held in place by the pins 36. The mask 34 also provides for securement of the film 28. The mask 34 includes a lip that extends partially over a top surface of the pointer 15 and also the film 28.

The pointer 15 includes a bottom surface 42. The example bottom surface 42 is covered by the mask 34. The bottom surface 42 may also include a coating that reflects and directs light within the pointer 15 such that light is not emitted through the bottom surface 42.

The example film 28 includes a top coating 38 and a bottom coating 40. The top coating 38 replicates and provides a metallic appearance. The metallic appearance is provided by a paint coating, or by application of ink through a printing process. The coating applied to the top surface can be applied by any process that is known. The example coating provides a desired metallic or chrome appearance. This coating is also semi-transparent such that when the pointer is illuminated, that illumination is visible through the film 28. In this way, the pointer assembly 16 provides two substantially unique appearances. During daylight conditions where the pointer 16 is not illuminated, the pointer assembly 16 appears metallic or chrome. During low light or night time conditions when the pointer assembly 16 is illuminated, the pointer assembly 16 provides a desired illuminated appearance to enhance and improve viewing of the indications on the gauge face 12.

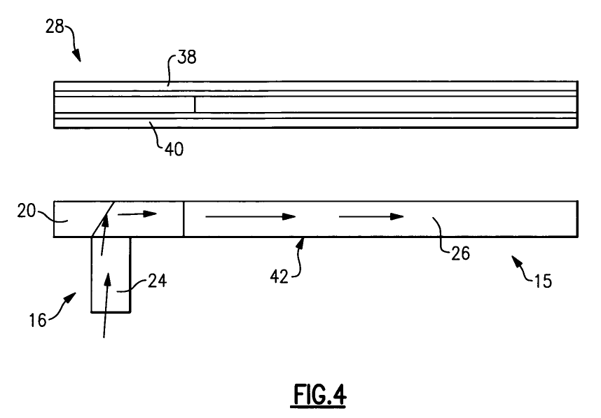

Referring to FIG. 4, the example pointer 15 includes the reflective surfaces required to direct light through the pointer portion 26 to provide the desired illumination. The example film 28 includes the top coating 38 that provides the first appearance visible in daylight conditions. The example film 28 may also include a second coating 40 disposed on a bottom surface that contacts the pointer 15. The coating 40 can be included to provide for the even uniform distribution of light with the pointer 15. The coating 40 can include white, gray paint or ink formulated to evenly distribute light emitted by an illuminated pointer.

The example film 28 is semi-transparent to provide an original non-illuminated appearance, and a secondary illuminated appearance. The example pointer assembly 16 provides a metallic appearance in non-illuminated conditions; however, other coatings can be utilized to provide any desired appearance such as different colors, or textures as desired to provide the desired appearance. The material for the film 28 is preferably selected to provide the desired semi-transparent characteristics that provide for the transmission or viewing of the illuminated pointer in a lighted condition, while providing a uniform non-illuminated appearance in for daylight conditions.

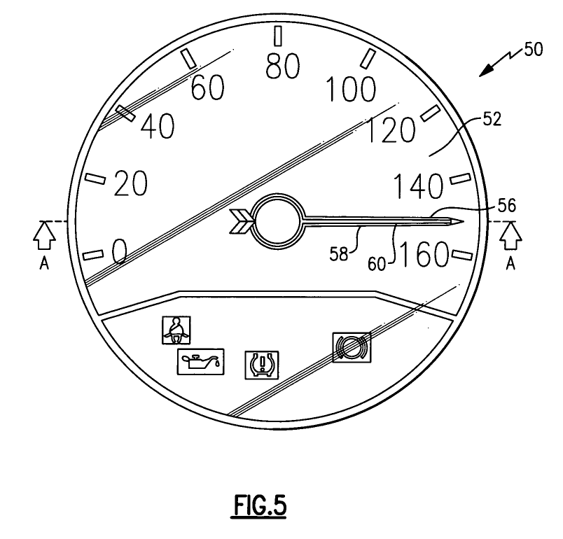

Referring to FIG. 5, another dial assembly 50 includes an illuminated pointer assembly 56 with a first color 58 and a second 60 that defines a multi-colored pattern. The dial assembly 50 includes a dial face 52 with a plurality of numerals that define a desired scale indicative of a vehicle operating condition. The pointer assembly 56 is multi-colored when illuminated to provide a desired appearance.

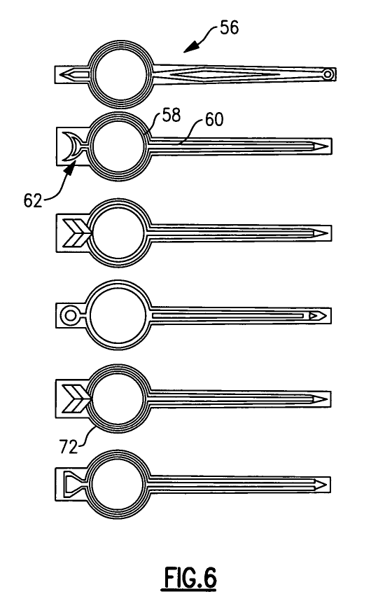

Referring to FIG. 6, several example pointer assemblies 56 are shown that include more than one color combined to define a desired multi-colored pattern 62. The multi-colored pattern 62 is formed with a polycarbonate film that is printed with an ink, paint or other coating that provides illumination in the desired colors. FIG. 6 illustrates several example multi-colored patterns and possible combinations of colors and various patterns 62. A worker skilled in the art with the benefit of this disclosure will understand that many different color and pattern combination are within the scope of this invention.

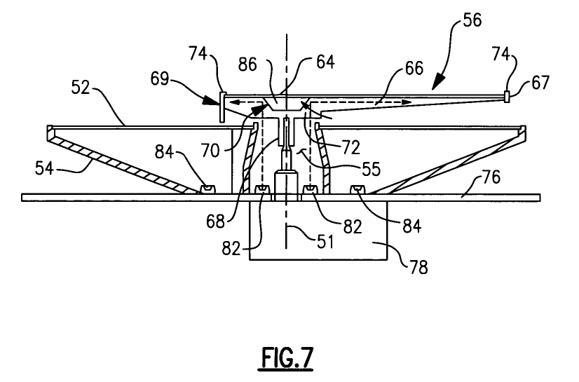

Referring to FIG. 7, the example dial assembly 50 is shown in cross-section and includes a printed circuit board 76 on which is mounted a light housing 54. The light housing 54 includes a central portion 55 with light sources 82 for providing illumination to the pointer assembly 56. The pointer assembly 56 is mounted on a shaft of a motor 78 that facilitates rotation relative to the dial face 52. The pointer assembly 56 includes a pointer body 66 with a reflective surface 70. The reflective surface 70 directs light toward ends 67 and 69 of the pointer body 66. The ends of the pointer body 66 include a mask 74 to preferentially block light from being transmitted through the each of the ends 67, 69. A plurality of light sources 84 are mounted on the printed circuit board 76 within the light housing 54 to provide illumination for the dial face 52.

The pointer assembly 56 includes a polycarbonate film 64 disposed on a top surface to selectively change a color illuminated according to a desired pattern printed on the polycarbonate film 64. The pointer body includes a cavity 86 that defines the reflective surface 70 that reflects light as desired through the pointer body 66. The example polycarbonate film 64 extends straight across the cavity 86. The light sources 82, 84 comprise white LED's. The white LED's are utilized as the polycarbonate film 64 provides the desired color upon illumination.

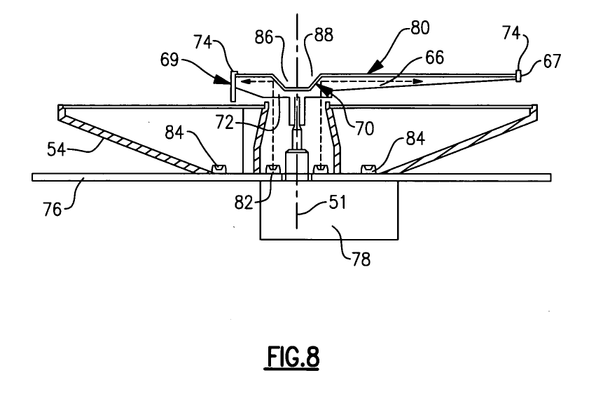

Referring to FIG. 8, another example cross-section is shown that includes the pointer assembly 56. In this example, a polycarbonate film 80 is formed to fit within the cavity 86 of the pointer body 66. The form fit polycarbonate film 80 provides a desired fit provide a desired illuminated pattern.

The pointer assembly 56 rotates about the axis 51. The reflective surface 70 is shown in cross-section but is a single continuous surface disposed concentrically about the axis 51. Because the reflective surface 70 is concentric about the axis 51, light from the light sources 82 is uniformly dispersed through the pointer body 66. Light is not only reflected toward the ends 67, 69 of the pointer body 66 but also within the circular region of the pointer 72 disposed concentrically about the axis 51. This circumferential dispersion of light provides for the illumination of the pattern about the axis of rotation that is shown in FIGS. 5 and 6.

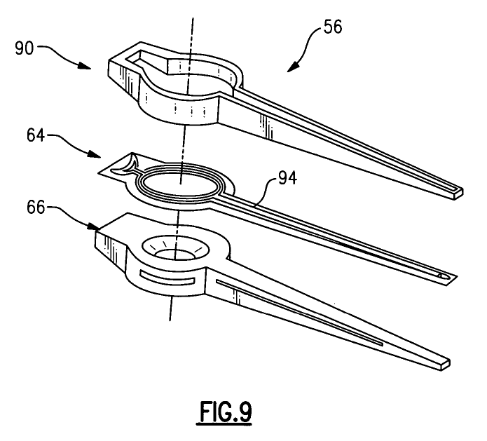

Referring to FIG. 9, an example pointer assembly 56 is shown in an exploded view and includes the pointer body 66 onto which is placed the polycarbonate film 64. The example polycarbonate film 64 includes the printed colors 94 that define the desired pattern when illuminated. A cap 90 fits over the pointer body 66 to hold the polycarbonate film 64 in place and to mask off the sides and ends to prevent light from being emitted in an undesired direction.

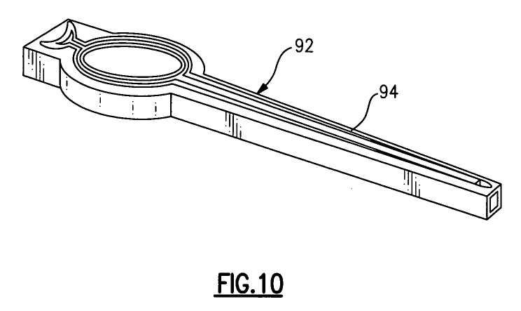

Referring to FIG. 10, a formed polycarbonate film 92 is illustrated that is molded to provide a complete fit about the pointer body 66. The formed polycarbonate film 92 is printed with a black ink 96 in areas were it is not desired for illumination. The formed polycarbonate film 92 fits over the pointer body 66 that provides for use of just the polycarbonate film 92 without the mask 90.

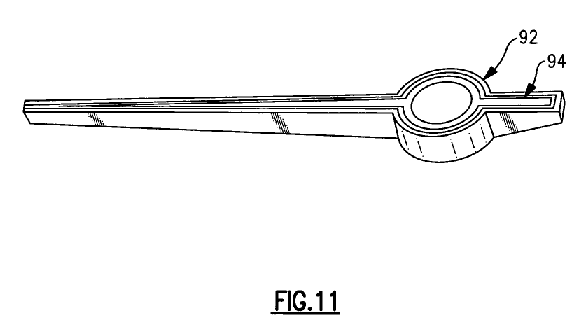

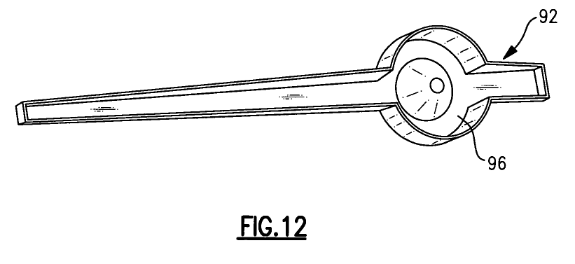

Referring to FIGS. 11 and 12, the formed polycarbonate sleeve 92 is shown in perspective view and includes the printed color 94. The formed polycarbonate sleeve 92 is fabricated in a process such as heat forming, or injection molding. The polycarbonate sleeve 92 includes a cavity 96 that conforms to the mating pointer body 66.

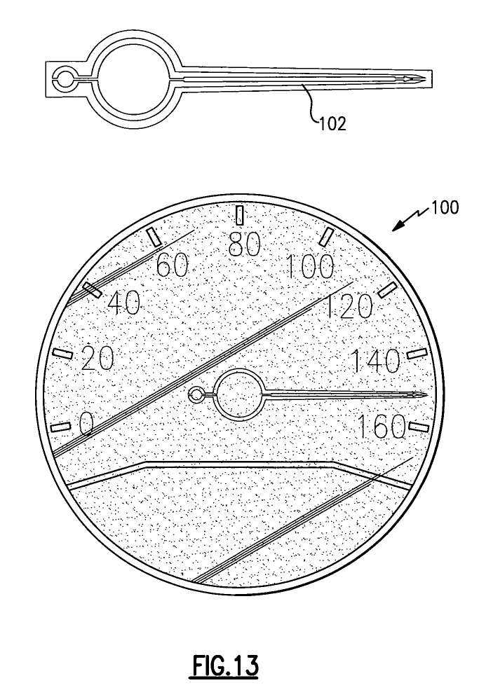

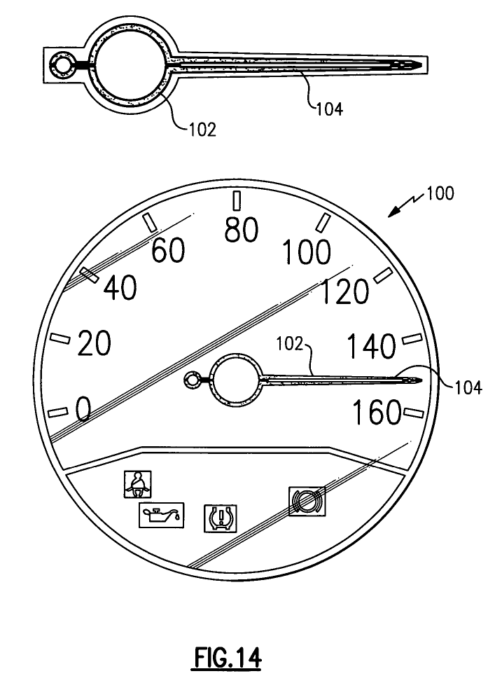

Referring to FIGS. 13 and 14, another example dial assembly 100 includes a blacked out image when not illuminated. The blacked out image provides a desired appearance and feature. When the vehicle is turned on, the dial is illuminated and becomes visible. However, without illumination nothing is visible. The pointer assembly 102 also is configured to provide the desired blacked out image when in a non-illuminated condition, but still provide the desired color and pattern 104 when illuminated as is shown in FIG. 14.

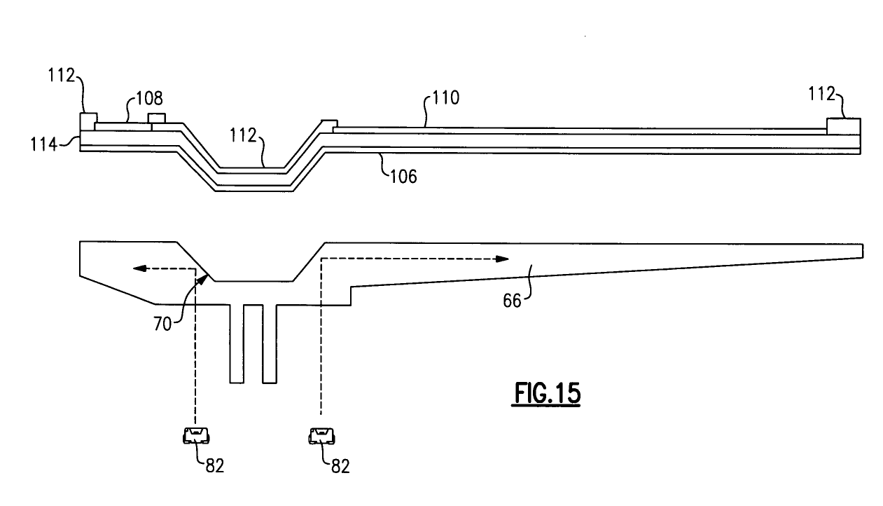

Referring to FIG. 15, the example pointer assembly 102 is shown in an exploded cross-sectional view and includes the body portion 66 with the reflective surface 70. The blacked out appearance is provided by a polycarbonate film 106 that includes the desired printed color and pattern as is shown in the previous examples. Layered on top of that polycarbonate film is a transparent sheet of polycarbonate material 114 to space a layer of smoked out printed polycarbonate film 108,110 away from the polycarbonate film 106. The smoked polycarbonate material 108 and 110 are pieced together with black printed material that provides a masking and blacked out appearance even when illuminated. The smoked out film 108,110 provides the blacked out appearance when not illuminated, but allows the color of the polycarbonate film 106 to show through when in an illuminated state.

Accordingly, the example dial assembly disclosed provide for the selective appearance of a pointer assembly by providing a film with a selective semi-transparent coating to provide the desired color, pattern and appearance in both illuminated and non-illuminated conditions.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An instrument display device comprising:
a dial face including markings indicative of a measured value;
a pointer movable relative to the gauge face for pointing to a marking, where the pointer includes a film covering a visible surface providing a first appearance when in a non-illuminated condition, and a second appearance when in an illuminated condition; and
a light source emitting light directed into the pointer for selectively illuminating the pointer.

2. The display device as recited in claim 1, wherein the first appearance comprises a metallic finish.

3. The display device as recited in claim 1, wherein the first appearance comprises a pattern of a desired color.

3. The display device as recited in claim 1, wherein the film comprise a semi-transparent material such that selective illumination of the pointer is visible.

4. The display device as recited in claim 1, wherein the film includes a coating on a bottom surface for uniformly distributing illumination from the pointer.

5. The display device as recited in claim 1, wherein the film is attached to the pointer by a pin.

6. The display device as recited in claim 1, including a shroud for blocking the visible illumination of desired portions of the pointer.

7. The display device as recited in claim 6, wherein the shroud covers a first side, a second side and a bottom of the pointer.

8. The display device as recited in claim 1, including a cap supported along an axis of rotation of the pointer.

9. The display device as recited in claim 1, wherein the dial face comprises a film the same as the film covering the pointer.

10. The display device as recited in claim 1, wherein the film covering the pointer includes a first printed color that defines a desired pattern.

11. The display device as recited in claim 10, wherein the film covering the pointer includes a second printed color.

12. The display device as recited in claim 10, including a second film including a smoked out color that is disposed over the film covering the pointer.

13. The display device as recited in claim 10, wherein the film is formed to fit over the pointer.

14. A pointer assembly for an instrument dial comprising:
a base portion;
a pointer portion extending from the base portion, the pointer portion including a top surface; and
a film supported on the top surface for providing a desired appearance.

15. The assembly as recited in claim 14, wherein the pointer includes a reflective surface concentric about an axis of rotation for directing light through the pointer portion.

16. The assembly as recited in claim 15, wherein the reflective surface directs light radially outward from the axis of rotation.

17. The assembly as recited in claim 14, wherein the film is semi-transparent such that illumination from the pointer portion is at least partially visible.

18. The assembly as recited in claim 14, wherein the film includes a coating defining a visible pattern.

19. The assembly as recited in claim 18, wherein the coating comprises an ink printed onto the film.

20. The assembly as recited in claim 19, wherein the coating comprises at least two different colors that define a desired pattern.
